(19) United States
(12) Patent Application Publication
(10) Pub. No.: US 2025/0319682 A1
(43) Pub. Date: Oct. 16, 2025

(54) CONVEYOR-BELT FILTER DEVICE AND METHOD FOR SETTING A TENSION AND/OR A SLACK OF AT LEAST ONE CLOSED MEANS OF TRACTION

(71) Applicant: FSM Frankenberger GmbH, Berlin (DE)

(72) Inventor: Guido Frankenberger, Wetzlar (DE)

(21) Appl. No.: 19/178,418

(22) Filed: Apr. 14, 2025

(30) Foreign Application Priority Data
Apr. 12, 2024 (DE) 10 2024 110 312.4

(51) Int. Cl. B30B 9/24

(52) U.S. Cl. CPC B30B 9/247

(57) ABSTRACT

An apparatus and associated method for mechanically cleaning a liquid polluted with solids, which is flowing in a channel. The apparatus includes a filter belt and a frame having a lower part and an upper part. The lower part and the upper part are adapted to adjust the deflection of the filter belt, the filter belt being guided over the lower part and the upper part and being movable along a circulatory path formed on the frame. The filter belt includes a chain and a plurality of filter elements disposed on the chain. The apparatus includes a gauge having at least one measuring unit for measuring a tension or a slack of the chain.

This application claims priority to German Patent Application No. 10 2024 110 312.4, filed on Apr. 12, 2024, the disclosure of which is hereby incorporated by reference.

### TECHNICAL FIELD

The invention relates to a conveyor-belt filter device, in particular a filter belt rake, for mechanically cleaning a liquid polluted with solids, which is flowing in a channel, the conveyor-belt filter device comprising an endless filter belt and a frame having a lower part and an upper part, the lower part and the upper part being adapted to adjust the deflection of the filter belt, the filter belt being guided over the lower part and the upper part and being movable along a circulatory path formed on the frame, the filter belt comprising at least one closed means of traction, preferably a chain, and a plurality of filter elements disposed on the means of traction. Furthermore, the invention relates to a method for setting a tension and/or a slack of at least one closed means of traction, preferably a chain, of an endless filter belt of a conveyor-belt filter device, in particular a filter belt rake, for mechanically cleaning a liquid polluted with solids, which is flowing in a channel, by means of a setting mechanism of the conveyor-belt filter device, the filter belt being guided over a lower part of the frame and an upper part of the frame and being movable along a circulatory path formed on the frame of the conveyor-belt filter device, the lower part and the upper part being adapted to adjust the deflection of the filter belt, the filter belt comprising a plurality of filter elements disposed on the means of traction.

### FIELD OF THE INVENTION

A conveyor-belt filter device of the type mentioned above, which is also referred to as a “paternoster filter rake”, is known, for example, from DE 10 2013 212 081 A1 and is used primarily for mechanically cleaning flowing waste water in a canal. The waste water flows through filter elements of an endless filter belt of the conveyor-belt filter device either transversely or in a longitudinal direction of the filter elements, and the filter elements carry a filtered-out material, which cannot pass through the filter elements, out of the canal. The filter belt is guided over a lower part of a frame and an upper part of the frame and is movable along a circulatory path formed on the frame of the conveyor-belt filter device, the lower part and the upper part being adapted to adjust the deflection of the filter belt. In the area of the upper part, which is disposed above a waste water level, a scraping device of the conveyor-belt filter device is usually provided, the scraping device typically being a rotating brush and removing filtered-out material adhering to the filter elements from the filter elements in a scraping process so that the filtered-out material can be discharged by means of a discharge device of the conveyor-belt filter device.

The filter elements are disposed on at least one closed means of traction of the filter belt. The means of traction is typically a chain and guided over at least one chain wheel of the lower part and at least one chain wheel of the upper part. The chain wheels and the chain form a chain drive. The chain wheel of the lower part is disposed on a deflection shaft of the lower part and the chain wheel of the upper part is disposed on a deflection shaft of the upper part. By means of a drive mechanism of the conveyor-belt filter device, which is provided to drive the deflection shaft of the upper part, a driving force can be applied to the chain wheel of the upper part, which can be transmitted to chain links of the chain via a toothing of the chain wheel of the upper part. Due to the form fit of the chain drive, no defined tension of the chain needs to be set in order to transmit a required driving force. Nevertheless, the tension must be set, similar to a motorcycle chain, in such a manner that the chain has a certain slack. The slack of a return strand of the chain occurs in an area of the lower part. The setting is carried out by means of a setting mechanism of the conveyor-belt filter device in an area of the upper part. The slack must be set so that the chain runs smoothly and does not fall out of the chain wheel of the lower part. Setting the tension too low or the slack too large causes the filter elements to drag across a bottom of the channel or the frame in the area of the lower part. This dragging causes increased wear of the conveyor-belt filter device, in particular of the filter elements, and in the worst case even destruction of the filter elements. Also, setting the tension too high leads to increased wear of the conveyor-belt filter device, in particular of the filter belt, the lower part, the upper part and the drive mechanism.

The area of the lower part, where the slack occurs, is located below the waste water level or is sometimes up to 10 m deep in the channel in almost all operating conditions of the conveyor-belt filter device and is therefore not visible to an operator from the operating floor, from where the tension or the slack is set. Even if the channel is comparatively shallow and the lower part is not submerged in the waste water, the area of the lower part is not visible to the operator as a function of an installation angle of the conveyor-belt filter device. Hence, it is not possible to visually check the setting. For this reason, the tension or the slack is set solely on the basis of the experience and feel of the operator. This frequently results in the tension being set too low or the slack being set too high or in excessive tension or over-tensioning, leading to increased wear of the conveyor-belt filter device. Due to a polygon effect, the tension fluctuates as a function of a position of the chain drive. The tension therefore fluctuates or oscillates when the filter belt is in operation, the tension being continuously increased and decreased. In particular when the slack is set while the filter belt is standing still and the tension is reduced to the maximum due to the polygon effect, there is a risk that the chain will be over-tensioned during operation due to the polygon effect, in particular at the tension increased to the maximum, which will result in particularly high wear of the conveyor-belt filter device.

### SUMMARY

Hence, the object of the present invention is to propose an apparatus, such as a conveyor-belt filter device, and a method that enable the conveyor-belt filter device to operate with less wear.

The conveyor-belt filter device, in particular the filter belt rake, according to the invention for mechanically cleaning a liquid polluted with solids, which is flowing in a channel, comprises a filter belt and a frame having a lower part and an upper part, the lower part and the upper part being adapted to adjust the deflection of the filter belt, the filter belt being guided over the lower part and the upper part and being movable along a circulatory path formed on the frame, the filter belt comprising at least one closed means of traction, preferably a chain, and a plurality of filter elements disposed on the means of traction, the conveyor-belt filter device comprising a measuring mechanism, such as a gauge, with at least one measuring unit for measuring a tension and/or a slack of the means of traction, preferably in an area of the lower part.

According to the invention, the conveyor-belt filter device, in particular the filter belt rake, for mechanically cleaning a liquid polluted with solids, which is flowing in a channel, comprises an endless filter belt and a frame having a lower part and an upper part, the lower part and the upper part being adapted to adjust the deflection of the filter belt, the filter belt being guided over the lower part and the upper part and being movable along a circulatory path formed on the frame, the filter belt comprising at least one closed means of traction, preferably a chain, and a plurality of filter elements disposed on the means of traction. The conveyor-belt filter device can be used for mechanically cleaning flowing waste water in a channel. The waste water can flow through the filter elements transversely or in a longitudinal direction of the filter elements, and the filter elements can carry a filtered-out material, which cannot pass through the filter elements, out of the channel. The filter elements are attached to the means of traction. Preferably, the filter belt can comprise two means of traction. In this case, the filter elements can each be attached to a first means of traction by a first end of the filter elements and to a second means of traction by a second end of the filter elements so that the filter elements can be disposed between the traction means. The filter elements can be in the form of sieves or rakes. The lower part and the upper part can each comprise a deflection shaft and at least one wheel disposed on the deflection shaft in question. The wheels and the means of traction can form a traction drive. Preferably, the means of traction can be a chain. The wheels can be chain wheels. The chain wheels and the chain can form a chain drive. The chain can be composed of chain links. The chain can be a roller chain, for example. In this case, the chain links can have rollers or bushes in addition to outer and inner plates. The rollers can be disposed between the inner plates. The lower part can also comprise a rigid guideway instead of the deflection shaft and the wheel disposed on the deflection shaft.

According to the invention, the conveyor-belt filter device comprises a measuring mechanism having at least one measuring unit for measuring a tension and/or a slack of the means of traction. The provision of the measuring mechanism and the measuring unit makes it possible to measure the tension and/or the slack. In turn, the ability to measure the tension and/or the slack makes it possible to set the tension and/or the slack in a controlled manner, which in turn enables the conveyor-belt filter device to operate with less wear. If the filter belt comprises two or more means of traction, only one measuring unit for a single means of traction may be provided. However, a separate measuring unit for each means of traction may also be provided. The measuring unit can be a mechanical measuring unit or an electrical measuring unit.

In a preferred embodiment of the conveyor-belt filter device, the measuring unit can be used to measure the tension and/or the slack of a return strand of the means of traction in an area of the lower part since the slack occurs in the area of the lower part on a side of the means of traction that is running downwards when the conveyor-belt filter device is being operated. The tension and/or the slack of the means of traction or of the return strand can then be measured upstream of the lower part and adjacent to the lower part in a direction of circulation of the filter belt or the means of traction by means of the measuring unit.

In a preferred embodiment of the conveyor-belt filter device, the conveyor belt can comprise two chains, which can each be composed of chain links, and the filter elements can each be disposed between two chain links of the chains. In this case, the filter elements can each be disposed between the two chain links and be attached to a respective chain link of a first chain by the first end and to a respective chain link of a second chain by the second end.

In a preferred embodiment of the conveyor-belt filter device, the measuring unit can comprise a lever mounted movably, preferably rotatably, on the frame, at least one pressure-applying element, in particular a spring element and/or a weight element, and at least one gauging element disposed on the lever, in particular a roller and/or a skid, and the pressure-applying element can push the lever in the direction of the filter belt, in particular of the means of traction, in such a manner that the gauging element can be pressed against or onto the means of traction and/or the filter elements. The gauging element can be in contact with the means of traction and/or the filter elements with part of a surface of the gauging element in order to gauge the means of traction and/or the filter elements. Preferably, the gauging element can be pressed against the return strand in the area of the lower part. Preferably, the means of traction is gauged since, in contrast to the filter elements, it is not directly situated in a waste water stream. This reduces the risk of contaminants wrapping around the measuring mechanism or the measuring unit. The roller can form a recess that can serve to enable the rollers of the roller chain to pass. In this case, the rollers of the roller chain can be in contact with a bottom of the recess. Preferably, the measuring unit can comprise two rollers disposed next to each other on a common axis of the measuring unit. In this case, the rollers can form a recess together. The plates on one side of the roller chain can then be in contact with one roller and the plates on the other side of the roller chain can be in contact with the other roller. This enables optimized gauging and guidance of the means of traction. The lever can be movable or rotatable as a function of the tension or the slack, meaning a position or a deflection of the lever can be changed as a function of the tension or the slack. The position or the deflection of the lever can therefore be used as a measure of the tension or the slack. Such a design of the measuring unit as a mechanical measuring unit is particularly robust and insensitive to dirt and therefore particularly fail-safe, in particular compared to a design of the measuring unit as an electrical measuring unit with a sensor, which can be provided as an alternative to the mechanical measuring unit.

In a preferred embodiment of the conveyor-belt filter device, the measuring unit can comprise a linkage, which can be coupled to the lever. The movement or the rotation of the lever can lead to a movement of the linkage coupled to the lever. Therefore, a position of the linkage, in particular a position of an end of the linkage not coupled to the lever, can be used as a measure of the tension or the slack. The linkage can be coupled to the lever at one end and be guided at the other end or with the end in an area above a waste water level or in an area of the upper part or in an area of an operating floor, from where the tension or the slack can be set by an operator, so that the position of the linkage or the position of the end can be perceived by the operator. The linkage can comprise at least one bar. The linkage can comprise a single bar or a plurality of bars, which are coupled, preferably hinged, to each other. The bars can be disposed in series.

In an alternative embodiment of the conveyor-belt filter device, the measuring unit can comprise at least one sensor, preferably a proximity sensor or a proximity switch. The sensor can be disposed on the frame. Preferably, the sensor can measure the tension or the slack of the return strand in the area of the lower part. Such a design of the measuring unit as an electrical measuring unit is particularly compact, in particular compared to the mechanical measuring unit.

In a preferred embodiment of the conveyor-belt filter device, the measuring mechanism can comprise a displaying unit for displaying a value of the tension and/or the slack. While observing the displayed value, the operator can then set the tension or the slack in such a manner that the tension or the slack is within a target range. Due to a polygon effect, the tension and/or the slack can fluctuate as a function of a position of the traction drive. The tension or the slack can therefore fluctuate or oscillate when the filter belt is in operation, and the tension or the slack can be continuously increased and decreased. Preferably, the tension and/or the slack can be set in such a manner that the tension and/or the slack are fully within the target range despite the fluctuations of the tension and/or the slack due to the polygon effect when the filter belt is in operation. The measuring unit, in particular the sensor of the measuring unit, can interact with, in particular be connected to, the displaying unit.

In a preferred embodiment of the conveyor-belt filter device, the linkage can be coupled to the lever with a first end of the linkage and can have an indicator at a second end of the linkage; the indicator can be configured to interact with a scale of the displaying unit, in particular a range scale, in such a manner that the value of the tension and/or the slack can be read from a position of the indicator in relation to the scale. In this case, the displaying unit can be a mechanical displaying unit. The range scale can have a good range. If the indicator is within the good range, the operator can deduce that the tension or the slack is within a target range. If the indicator is outside the good range, the operator can deduce that the tension or the slack is outside the target range. The operator can then adjust the tension or the slack until the indicator is within the good range. Furthermore, the displaying unit can comprise a guide means by means of which the linkage or the second end can be guided. The guide means can be a box, and the linkage or the second end can engage an opening of the box.

In an alternative embodiment of the convey-or-belt filter device, or in an embodiment combined therewith, the linkage can be coupled to the lever with one end, or the first end, of the linkage, and the linkage can have a second end, or the second end, and the displaying unit can comprise at least one sensor by means of which a position of the second end can be detected. The sensor can be used to determine, on the basis of the position of the second end, whether the tension or the slack is within a target range. In this case, the displaying unit can be an electrical displaying unit. The displaying unit can comprise an output means, which is connected to the sensor, for outputting a visual and/or acoustic signal, which can inform the operator about the value of the tension or the slack. The output means can comprise a indicator, or the indicator, and a scale, or the scale, in particular a range scale. The output means can have a display screen.

In a preferred embodiment of the conveyor-belt filter device, the conveyor-belt filter device can comprise a setting mechanism for setting the tension and/or the slack, the setting mechanism preferably being disposed in an area of the upper part.

In a preferred embodiment of the conveyor-belt filter device, the conveyor-belt filter device can comprise a drive mechanism, such as an actuator, for driving a deflection shaft of the upper part. In this case the wheel disposed on the deflection shaft of the upper part can be a drive wheel, and the wheel disposed on the deflection shaft of the lower part can be a driven wheel. The actuator can apply a driving force to the drive wheel, which can be transmitted to the means of traction. The actuator can comprise a drive motor. Instead of the deflection shaft and the wheel disposed on the deflection shaft, the lower part can also comprise the rigid guideway.

In a preferred embodiment of the conveyor-belt filter device, the conveyor-belt filter device can comprise a discharge device for discharging a filtered-out material. The discharge device can have a discharge channel. By way of the discharge channel, the filtered-out material can then be guided to an installation disposed downstream of the conveyor-belt filter device.

In a preferred embodiment of the conveyor-belt filter device, the conveyor-belt filter device can comprise a scraping device for scraping the filter elements, in particular a rotating brush. A filtered-out material adhering to the filter elements can be removed from the filter elements as a result of the scraping. The scraping device can comprise a drive motor

In the method according to the invention for setting a tension and/or a slack of at least one closed means of traction of an endless filter belt of a conveyor-belt filter device, in particular a filter belt rake, for mechanically cleaning a liquid polluted with solids, which is flowing in a channel, by means of a setting mechanism of the conveyor-belt filter device, the filter belt being guided over a lower part of a frame and an upper part of the frame and being movable along a circulatory path formed on the frame of the conveyor-belt filter device, the lower part and the upper part being adapted to adjust the deflection of the filter belt, the filter belt comprising a plurality of filter elements disposed on the means of traction, the tension and/or the slack is measured by means of at least one measuring unit of a measuring mechanism of the conveyor-belt filter device. For the advantageous effects of the method, reference is made to the description of the advantages of the device according to the invention.

In a preferred embodiment of the method, the tension and/or the slack can be set while the filter belt is standing still. Alternatively, the setting can also be carried out while the filter belt is in operation. The setting can be carried out in such a manner that the tension or the slack lies within a target range. The setting can be carried out using a torque wrench, for example.

In a preferred embodiment of the method, the tension and/or the slack can be measured while the filter belt is standing still. The measurement can be carried out during setting.

In a preferred embodiment of the method, the tension and/or the slack can be measured while the filter belt is in operation. This allows a size of a fluctuation of the tension or the slack caused by the polygon effect, the tension or the slack fluctuating or oscillating when the filter belt is in operation, to be measured. A measurement result obtained for the size of the fluctuation can be used to make the setting more precise. A magnitude of a manifestation of the polygon effect is influenced in particular by a number of teeth of the chain wheels and/or a length of the chain links.

In a preferred embodiment of the method, the setting can be carried out in such a manner that the tension and/or the slack can be fully within a target range despite fluctuations of the tension and/or the slack due to a polygon effect when the filter belt is in operation. In this case, the tension or the slack cannot leave the target range even in the face of a tension increased to the maximum or a tension decreased to the maximum.

### BRIEF DESCRIPTION OF THE DRAWINGS

Hereinafter, a preferred embodiment of the invention is explained in more detail with reference to the accompanying drawings.

FIG. 1 is a side view of a conveyor-belt filter device;

FIG. 2 is a front view of the conveyor-belt filter device;

FIG. 3 is a sectional view of the conveyor-belt filter device along an axis A-A shown in FIG. 2;

FIG. 4 is an enlarged view of an area B shown in FIG. 3;

FIG. 5 is an enlarged view of an area C as shown in FIG. 3.

### DETAILED DESCRIPTION

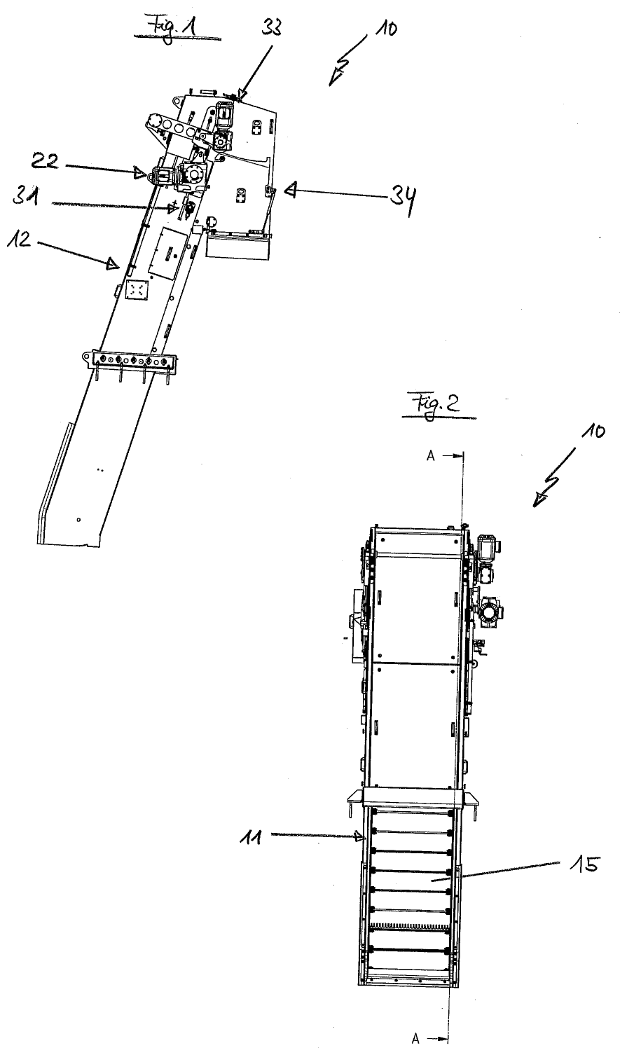

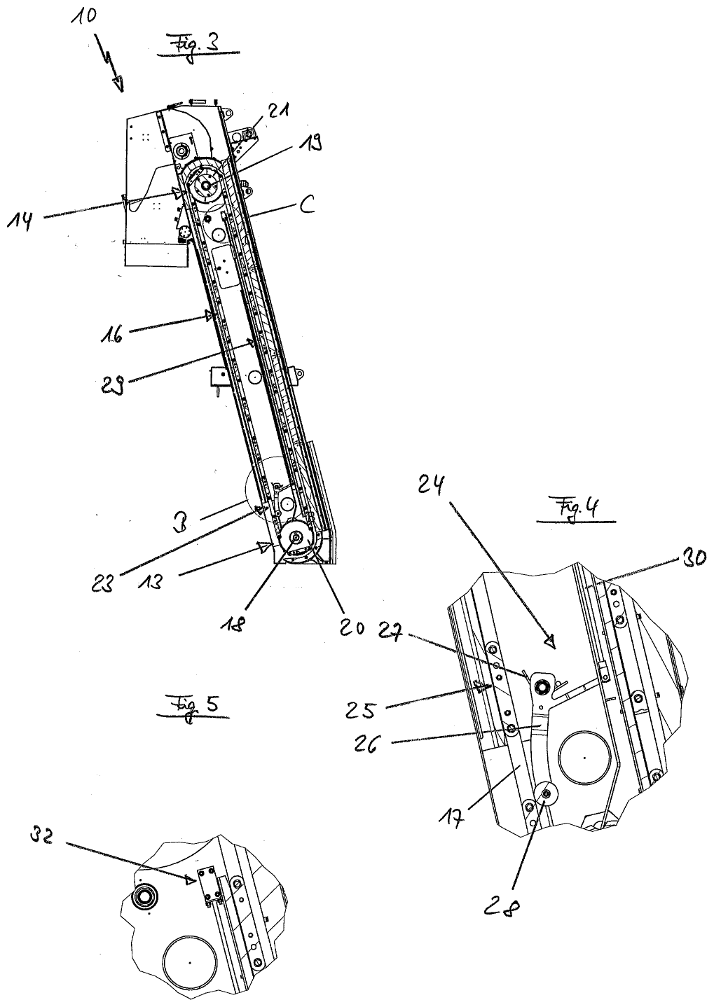

A synopsis of FIGS. 1 to 5 shows an apparatus 10, such as a conveyor-belt filter device, for mechanically cleaning a liquid contaminated with solids, which is flowing in a canal (not shown), the conveyor-belt filter device comprising a filter belt 11 and a frame 12 having a lower part of the frame 13 and an upper part of the frame 14, the lower part 13 and the upper part 14 being adapted to adjust the deflection of the filter belt 11, the filter belt 11 being guided over the lower part 13 and the upper part 14 and being movable along a circulatory path formed on the frame 12. The filter belt 11 comprises a plurality of filter elements 15 and at least one chain. There may be two chains, of which only one chain 16 is visible here, the chains each being composed of chain links, of which only chain links 17 of chain 16 are visible here, the filter elements 15 each being disposed between a chain link 17 of chain 16 and a chain link of the other chain. The lower part 13 and the upper part 14 each comprise a deflection shaft 18, 19 and two chain wheels disposed on the deflection shaft 18, 19, of which only one chain wheel 20 disposed on deflection shaft 18 and one chain wheel 21 disposed on deflection shaft 19 are visible here, the chains being guided over the chain wheels. In particular, chain 16 is guided over chain wheels 20, 21. The apparatus 10 further comprises a drive mechanism, such as an actuator 22, for driving the deflection shaft 19 of the upper part 14. The apparatus 10 further comprises a setting mechanism (not shown) for an operator to set a fixed tension and/or the slack of the chains, the setting mechanism being disposed in an area of the upper part 14. Furthermore, the apparatus 10 comprises a measuring mechanism, such as a gauge 23, with a measuring unit 24 for measuring a tension and/or a slack of the chain 16. The tension and/or the slack of a return strand 25 of the chain 16 in an area of the lower part 13 can be measured by means of the measuring unit 24. The measuring unit 24 comprises a lever 26 rotatably mounted on the frame 12, a spring element 27, and two rollers disposed next to each other on a common axis on the lever 26, of which only one roller 28 is visible here, the lever 26 being biased in the direction of the chain 16 by means of the spring element 27 in such a manner that the rollers are pressed against the return strand 25 in the area of the lower part 13. Furthermore, the measuring unit 24 comprises a linkage 29, the linkage 29 comprising a bar 30, the linkage 29, or the bar 30, being coupled to the lever 26 at one end and the linkage 29, or the bar 30, having an indicator (not shown) at the other end, the indicator being configured to interact with a range scale (not shown) of a display unit 31 of the gauge 23 for displaying a value of the tension and/or the slack in such a manner that the value of the tension and/or the slack can be read from a position of the indicator in relation to the scale. Furthermore, the displaying unit 31 comprises a guide means 32, by means of which the linkage 29, or the bar 30, can be guided at the other end, the guide means 32 being a box, the bar 30 engaging an opening (not shown) of the box at the other end. Furthermore, the apparatus 10 comprises a scraping device 33 for scraping the filter elements 15. Furthermore, the apparatus 10 comprises a discharge device 34 for discharging a filtered-out material. The apparatus 10 can be disposed in the channel in such a manner that the lower part 13, in particular, is located below a liquid level and the upper part 14, in particular, is located above the liquid level.

1. An apparatus for mechanically cleaning a liquid polluted with solids, which is flowing in a channel, comprising:
a filter belt (11):
a frame (12), having a lower part (13) and an upper part (14), the lower part and the upper part being adapted to adjust the deflection of the filter belt, the filter belt being guided over the lower part and the upper part and being movable along a circulatory path formed on the frame, the filter belt comprising at least one chain, and a plurality of filter elements (15) disposed on the at least one chain; and
a gauge (23) having at least one measuring unit (24) for measuring a tension or a slack of the at least one chain.

2. The apparatus according to claim 1, wherein the measuring unit (24) is configured to measure the tension or the slack of a return strand (25) of the at least one chain in an area of the lower part (13).

3. The apparatus according to claim 1, wherein the filter belt (11) comprises two chains (16), each chain being composed of chain links (17), the filter elements (15) each being disposed between two chain links of the chains.

4. The apparatus according to claim 1, wherein the measuring unit (24) comprises a lever (26) mounted on the frame (12) in a movable manner, at least one pressure-applying element, and at least one gauging element, in particular a roller (28) or a skid, disposed on the lever, the pressure-applying element pushing the lever in the direction of the filter belt (11) in such a manner that the gauging element is pressed against the at least one chain or the filter elements (15).

5. The apparatus according to claim 4, wherein the measuring unit (24) comprises a linkage (29) coupled to the lever (26).

6. The apparatus according to claim 1, wherein the measuring unit (24) comprises at least one proximity sensor.

7. The apparatus according to claim 1, wherein the gauge (23) comprises a displaying unit (31) for displaying a value of the tension or the slack.

8. The apparatus according to claim 5, wherein the linkage (29) is coupled to the lever (26) with a first end of the linkage, and a second end of the linkage has an indicator configured to interact with a scale of the displaying unit (31), in particular a range scale, in such a manner that the value of the tension or the slack can be read from a position of the indicator in relation to the scale.

9. The apparatus according to claim 5, wherein the linkage (29) is coupled to the lever (26) with a first end of the linkage, the linkage having a second end, the displaying unit (31) comprising at least one sensor configured to detect a position of the second end.

10. The apparatus according to claim 1, wherein the at least one chain is adapted to maintain a fixed tension or slack set by an operator.

11. The apparatus according to claim 1, further comprising an actuator (22) for driving a deflection shaft (19) of the upper part (14).

12. A method for setting a tension or a slack of at least one chain of a filter belt (11), for mechanically cleaning a liquid polluted with solids, which is flowing in a channel, comprising:
guiding the filter belt over a lower part (13) of a frame and an upper part (14) of the frame;
moving the filter belt along a circulatory path formed on the frame (12), wherein the filter belt comprises a plurality of filter elements (15) disposed on the at least one chain; and
measuring the tension or the slack.

13. The method according to claim 12, wherein the tension or the slack is set while the filter belt is standing still.

14. The method according to claim 12, wherein the tension or the slack is measured while the filter belt is standing still.

15. The method according to claim 12, wherein the tension or the slack is measured while the filter belt is in operation.

16. The method according to claim 12, wherein setting is carried out in such a manner that the tension or the slack are fully within a target range despite fluctuations of the tension or the slack due to a polygonal effect during the operation of the filter belt.

17. The apparatus according to claim 1, wherein the lower part of the frame comprises at least one wheel disposed on a shaft, or a rigid guideway.

18. The apparatus according to claim 1, wherein the upper part of the frame comprises at least one wheel disposed on a shaft.
